(19) United States
(12) Patent Application Publication
(10) Pub. No.: US 2014/0183318 A1
(43) Pub. Date: Jul. 3, 2014

(54) ADAPTER FOR SUPPORTING MOLDS

(71) Applicants: Ken Treske, Vernon Hills, IL (US); Aaron Treske, Vernon Hills, IL (US)

(72) Inventors: Ken Treske, Vernon Hills, IL (US); Aaron Treske, Vernon Hills, IL (US)

(21) Appl. No.: 13/733,759

(22) Filed: Jan. 3, 2013

(51) Int. Cl. F16M 13/00

(52) U.S. Cl. CPC F16M 13/00
USPC 248/346.01

(57) ABSTRACT

An elastic adapter for supporting baking molds. The elastic adapter may include an inner wall including a plurality of extruded inner projections extending radially inward and made of an elastic material. A mold may fit within and be secured by the inner projections. The elastic adapter may fit within a tray cavity of a tray.

### BACKGROUND OF THE INVENTION

The present invention relates to an adapter and, more particularly, to an adapter for supporting molds.

Currently, bakers and cooks increasingly express their creativity by creating food items in new and expressive shapes using molds. Molds are generally purchased in trays such as cupcake or candy trays. Each mold typically requires a new tray. The trays begin to stack up and require significant storage space. Further, most trays require the mold itself to have a flat bottom to rest on a cooking rack in an over or a cooling rack in a freezer. If the molds have a tapered or conical bottom that comes to a point, the bottom of the molds which make up the bottom of the tray cannot easily rest on grated heating or cooling racks. In these cases a super-structure is typically required that adds to the bulk of each tray. Also, most trays have set molds—users can't easily mix molds in the same tray. Existing inventions for modular tray systems require the purchase of a specialized base tray adding to the cost, clutter and storage requirements of those baking systems.

As can be seen, there is a need for an easy to store device for molds.

### SUMMARY OF THE INVENTION

In one aspect of the present invention, a device for supporting a mold, comprising: a cylindrical adapter comprising an outer wall and an inner wall; and a plurality of extruded inner projections extending radially inward from an inner surface of the cylindrical adapter, wherein the plurality of extruded inner projections comprises an elastic material.

In another aspect of the present invention, a plurality of extruded outer projections extends radially outward from an outer surface of the cylindrical adapter, wherein the plurality of outer projections comprises an elastic material.

In another aspect of the present invention, an extension of the extruded outer projections depends on a height relative to a bottom of the cylindrical adapter, whereby the extruded outer projections extend further in an upper cross section of the cylindrical adapter than in a lower cross section of the cylindrical adapter.

In another aspect of the present invention, the plurality of extruded inner projections comprises a polymer.

In another aspect of the present invention, the polymer is a urethane, silicone, or a combination thereof.

In another aspect of the present invention, the mold tapers from a top of the mold to a bottom of the mold, wherein the bottom of the mold is narrower than the top of the mold.

In another aspect of the present invention, the plurality of extruded outer projections comprises a larger circumference than a tray cavity of a tray.

In another aspect of the present invention, a device for supporting a mold, comprising: an adapter comprising elastic material, having an inner wall and an outer wall, wherein the adapter is configured to fit in a tray cavity of a tray; and a plurality of projections projecting radially from the inner wall, wherein the plurality of projections is configured to receive and secure the mold.

These and other features, aspects and advantages of the present invention will become better understood with reference to the following drawings, description and claims.

### BRIEF DESCRIPTION OF THE DRAWINGS

FIG. 1 is a perspective view of the invention shown in use;

FIG. 2 is a perspective view of the invention;

FIG. 3 is a side view of the invention;

FIG. 4 is a top view of the invention;

FIG. 5A is a section detail view of the invention along line 5-5 in FIG. 1;

FIG. 5B is a section detail view of the invention adapting itself to an alternative mold shape;

FIG. 5C is a section detail view of the invention adapting itself to an alternative mold shape;

FIG. 6 is a perspective view of the invention illustrating how the inner projections interact with the mold to create a grip;

FIG. 7 is a section view of an alternate embodiment of the invention;

FIG. 8 is a section view of an alternate embodiment of the invention; and

FIG. 9 is a side view of the invention illustrating stacking of item 24 exemplary mold(s).

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an elastic adapter for supporting baking molds. The elastic adapter may include an inner wall including a plurality of extruded inner projections extending radially inward and made of an elastic material. A mold may fit within and be secured by the inner projections. The elastic adapter may fit within a tray cavity of a tray.

The present invention may include an elastic adapter that fits inside a cavity that may support a mold with a tapered bottom. The present invention may use existing trays, such as cupcake trays and therefore a user may not have to invest in new trays to acquire new molds. The molds may be acquired individually or in sets and may utilize the elastic adapters within the cavities of existing trays for support when placed in an oven or a cooler.

In certain embodiments, the molds may have tapered or conical bottoms and may include designs such ice cream cones, a flower bud, a martini or the like. The present invention may allow the molds to be held securely in place using the existing trays and thereby do not require any new specialized trays that typically include additional superstructure to support molds with conical bottoms. The extra trays may add cost and require increased storage while the present invention may save storage space. For example, the elastic adapters may be stored within the cavities of existing trays, requiring no additional space. The individual molds may be stacked vertically. The space required to store 6 or 12 stacked molds can be as little as 15% of the space required to store a tray that includes the same 6 or 12 molds.

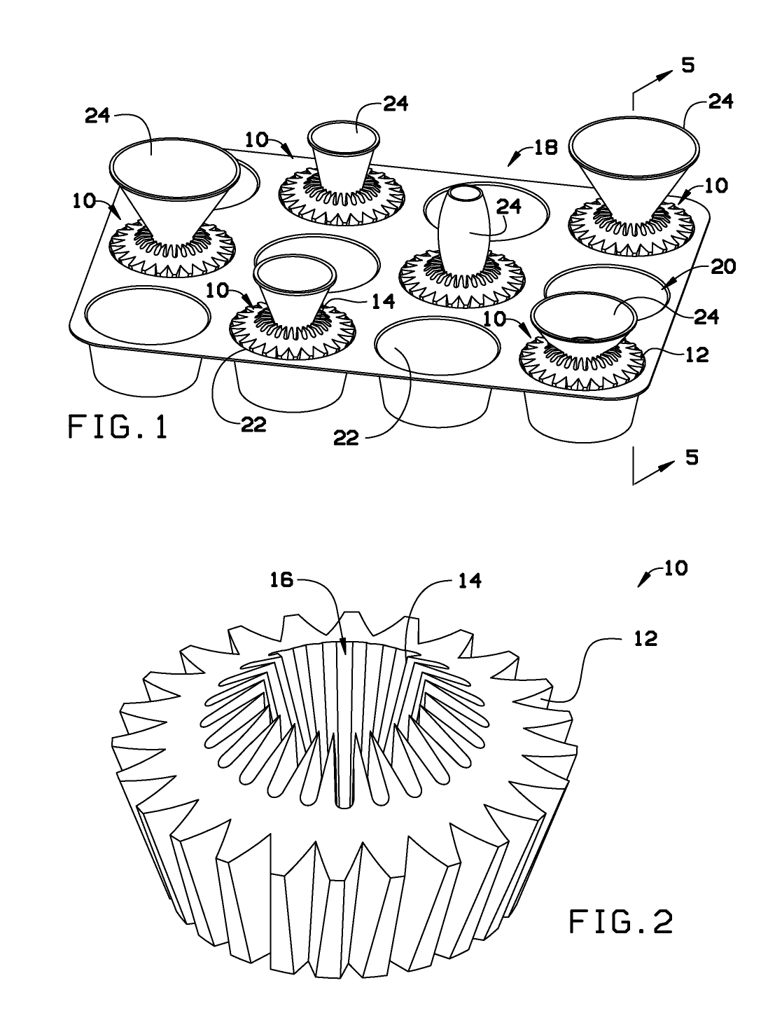

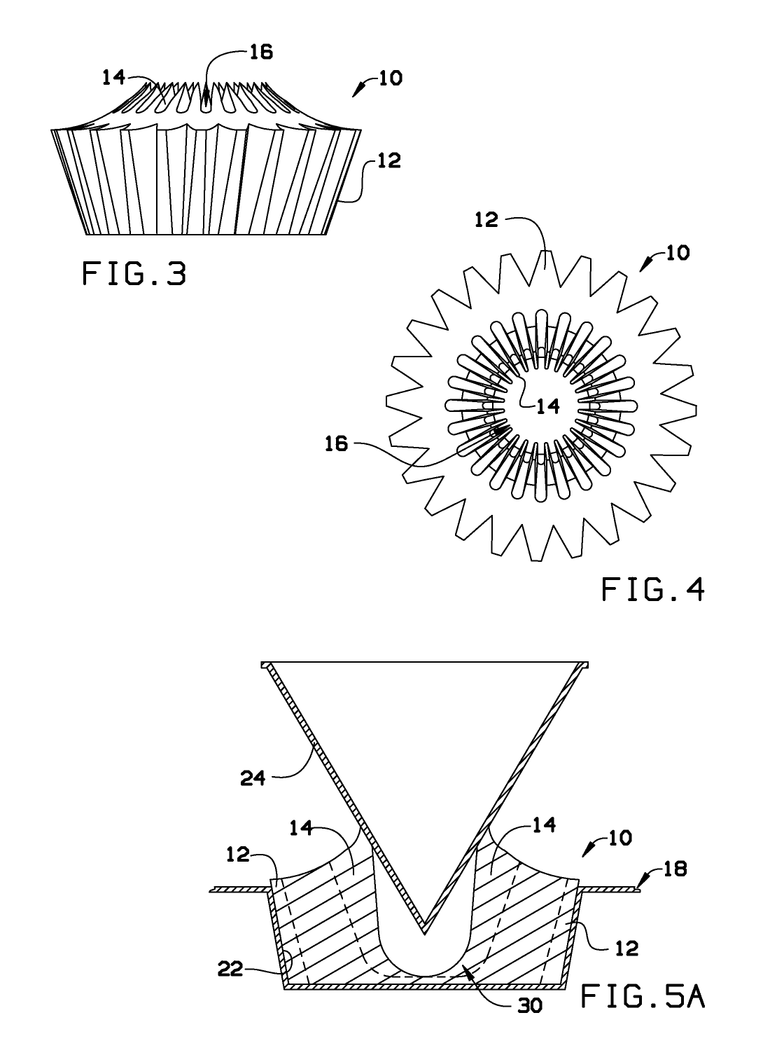

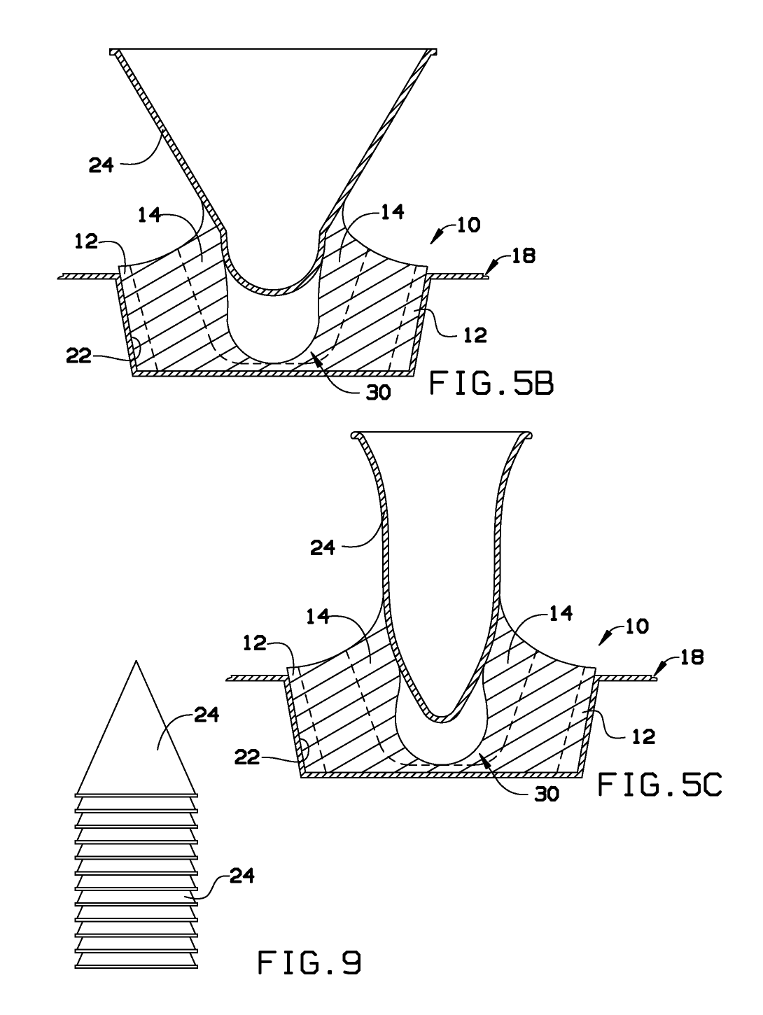

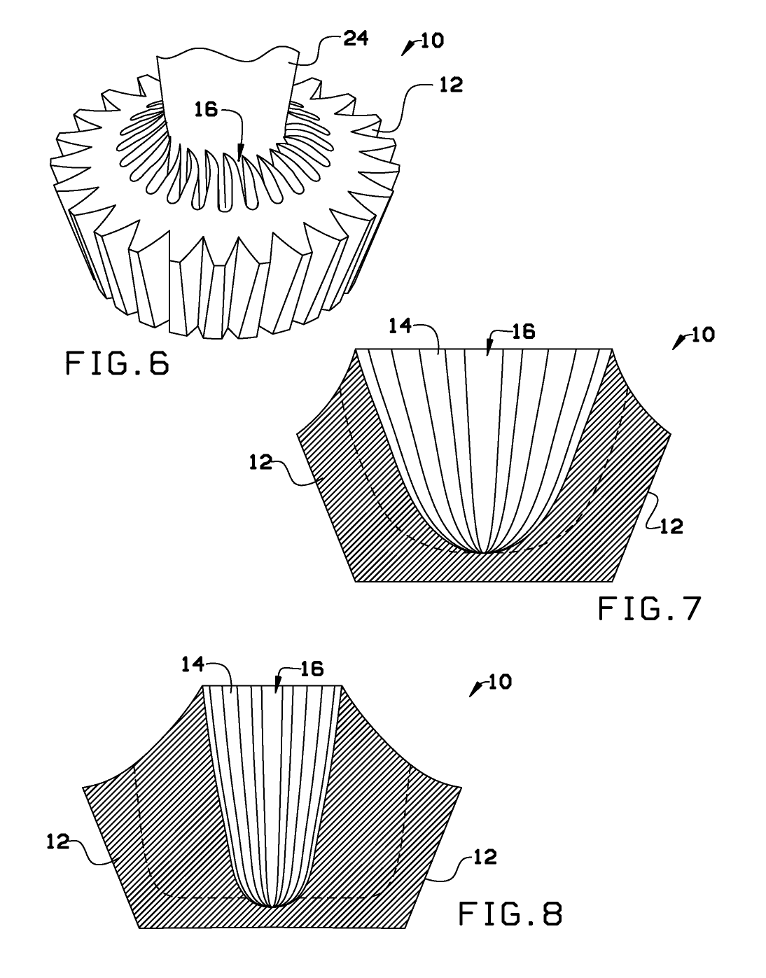

Referring to FIGS. 1 through 9, the present invention may include an adapter 10. In certain embodiments, the adapter 10 may include elastic materials and thereby have elastic qualities. Therefore, the adapter 10 may be made of elastic materials, such as, but not limited to, polymers and metals. For example, the elastic materials may include synthetic rubbers, natural rubbers, and bendable metals. For example, the elastic material may include urethane, silicone, Nitrile Neoprene, light gauge aluminum or metals that are fabricated so that the inner and outer projections are thin enough or hollow allowing the natural flexibility of soft metals to create an elastic quality. The specific use of the adapter 10 may determine the type of elastic material. For example, if the user uses the adapter 10 for high temperature applications, such as baking, the adapter 10 may be made of silicone or other oven and food safe materials.

The adapter 10 may be in any shape to fit within a tray cavity 20 of a tray 18. In certain embodiments, the adapter 10 may be configured to fit inside the cavities of an existing tray 18, such as cupcake trays. Therefore, the dimensions of the adapter 10 may complement the size of a tray cavity 20. For example, a large cavity adapter may be about 3.6″ wide; a medium cavity adapter may be about 2.8″ wide and a mini adapter may be about 1.9″ wide. In such embodiments, the adapter 10 may be a cylindrical adapter 10 and may support itself against the tray cavity walls 22. To further secure the cylindrical adapter 10 within the tray cavity 2, the outside wall 12 of the cylindrical adapter 10 may include a gripping. For example, the gripping may be a plurality of extruded outer projections extending radially outward from an outer wall of the cylindrical adapter 10.

In certain embodiments, the circumference of the upper edge of the outside wall 12 of the adapter may be slightly larger than the circumference of the upper edge of the tray cavity 20. This may create pressure and the outside edge of the adapter 10 may compress within the tray cavity 20 and occupy space that is left vacant by the plurality of extruded outer projections. The elastic qualities of the adapter 10 may allow the plurality of extruded outer projections and outside wall 12 to press up against the outside edge of the tray cavity 20 keeping the cylindrical adapter 10 in place.

The adapter 10 may further include an inner wall creating an elastic cavity 16 near the center of the adapter 10. The elastic cavity 16 may include an inner gripping 14. The inner gripping 14 may include a plurality of extruded inner projections extending radially inward from an inner surface of the cylindrical adapter, such as ridges, ribs or fingers. In certain embodiments, the plurality of extruded inner projections may include elastic materials. Thereby the inner gripping 14 of the elastic cavity 16 may be configured to secure the mold 24 in place.

The mold 24 may have a tapered bottom 30. For example, the mold 24 may have a rounded or conical bottom. As illustrated in the Figures, the tapered bottom 30 may fit within the elastic cavity 16 of the cylindrical adapter 10. In certain embodiments, the diameter of the tapered bottom 30 may be large enough to engage with the inner gripping 14, such as the plurality of extruded inner projections. The mold 24 may be placed within the cylindrical adapter 10 by applying pressure and slightly twisting the mold 24. The elastic nature of the extruded inner projections may be biased to return to their natural starting position and thereby securing the mold 24 within the adapter cavity 16.

In certain embodiments, the extruded inner projections may be of equal size and shape, and therefore may place equal and symmetrical pressure around the tapered bottom 30. The pressure may hold the bottom of the mold 24 in place with sufficient force that it may be held steady as the tray 18 is moved from preparation to cooking or cooling. As illustrated in FIGS. 7 and 8, the bottom edge of the inner rubber ribs may be tapered toward the center so as to create more contact with the bottom of the tapered mold. The extended top of rubber ribs also serves to extend the length of the fingers that have contact with the bottom of the tapered mold. The result may include more surface contact between the rubber ribs and the bottom of the mold which improves the amount of symmetrical force to hold the mold in place.

The length, the height and the amount of taper of the extruded inner projections may vary to accommodate a range of mold sizes and shapes. The adapter cavity 16 may be able to accept and support the size and weight of the molds as they are filled with food materials. The variation of uses may impact the size of extruded inner projections, and the durometer of the material. In certain embodiments, the different sized adapters may fit within one another's adapter cavity 16. The nested adapters may allow for a set of adapters that may fit a range of tray cavity sizes, which may allow for a larger range of tapered mold bottoms.

In certain embodiments, the existing tray 18 may not be needed at all. For instance, a user may only want to produce one item. In such examples, the mold 24 may be small enough that the tray 18 is not needed for extra support and stability. The mold 24 may be inserted into the adapter 10 and the adapter 10 placed on the baking or cooling rack directly. The flat bottom of the adapter 10 may rest directly on the rack. Additional support may not be needed and the user may not need to carry multiple molds 24 into and out of the oven.

As illustrated in FIG. 1, the present invention may accept molds 24 of different shapes and sizes within the same tray 18. The number of diverse molds 24 that may be used in one tray 18 may be the equivalent to the number of cavities 20 in the existing tray 18. For example, one to twelve different molds could be configured on a standard cupcake tray which greatly reduces the number of cycles required to bake a diverse set of molds and reduces the number of trays used.

Methods of using the device may include the following. A user may place the cylindrical adapter 10 into the tray cavity 20 of an existing tray 18, insert the mold 24 into the elastic cavity 16 and fill the mold 24 with a food item such as batter. The user may safely move the tray 18 from a preparation table to an oven. The standard cupcake tray 18 may lay flat on the rack of the oven. The food item may then be cooked, baked or cooled. Once the food item has been completed, the food item may be removed from the mold 24. The individual molds 24 may be hand washed or stacked in a dishwasher for easy cleaning. The elastic adapters 10 may be placed in the cavity 20 of the cupcake tray 18 and the molds may be stacked vertically to allow for easy and efficient storage.

Additional embodiments of the invention include a mold that is large enough and asymmetrical enough that it may require the support of one or more tapered ends to be inserted into one or more elastic adapter cavities. The present invention may further be used in any operation that may include trays. For example, the present invention may be used in conjunction with candy-making, bread-baking and creating plaster or ceramic crafts or goods. Industrial applications use trays for the mass production of food, plastic and other molded items. The present invention may fit within existing trays but allow low cost molds to be customized and inserted into existing tray systems. This may aid in the rapid prototyping of new or custom products or the rapid production of short run items without requiring a full line change.

The gripping qualities of the invention may be used to secure light bulbs in hard to reach locations. Lighting in high ceilings can be difficult and frustrating to change. Bulbs can often times get stuck after prolonged use within their threaded socket. Removing the fragile glass bulbs can create breaking particularly when using poles to reach high ceiling lights. The adapter could replace the tread mechanism. Adapter fingers and adapter cavity may be configured to complement the bottom of the light bulb. The bulb may be quickly inserted and connect with electronics that run through the bottom of sides of the adapter. Rotating the device may secure and may loosen the adapter fingers to safely remove the bulb.

Another application may be for holding wall or ceiling art. An adapter may be secured to a wall or ceiling. A three dimensional object such as a sculpture, hook or other decorative piece can be secured by placing a tapered bottom into the complementary adapter cavity and adapter fingers. The objects may be quickly replaced to create a new look in the room or for seasonal, holiday time periods and the like.

It should be understood, of course, that the foregoing relates to exemplary embodiments of the invention and that modifications may be made without departing from the spirit and scope of the invention as set forth in the following claims.

What is claimed is:

1. A device for supporting a mold, comprising:
a cylindrical adapter comprising an outer surface and an inner surface; and
a plurality of extruded inner projections extending radially inward from an inner surface of the cylindrical adapter,
wherein the plurality of extruded inner projections comprises an elastic material,
wherein each of the plurality of extruded inner projections comprises a base extending from the inner wall and a bendable tip disposed towards a center of the cylindrical adapter,
wherein the plurality of extruded inner projections releasably retains an object in between the bendable tips by pressure applied to the object by the bendable tips.

2. The device of claim 1, further comprising a plurality of extruded outer projections extending radially outward from the outer surface of the cylindrical adapter, wherein the plurality of outer projections comprises an elastic material.

3. The device of claim 2, wherein an extension of the extruded outer projections depends on a height relative to a bottom of the cylindrical adapter, whereby the extruded outer projections extend further in an upper cross section of the cylindrical adapter than in a lower cross section of the cylindrical adapter.

4. The device of claim 1, wherein the plurality of extruded inner projections comprises a polymer.

5. The device of claim 4, wherein the polymer is a urethane, silicone, or a combination thereof.

6. The device of claim 1, wherein the mold tapers from a top of the mold to a bottom of the mold, wherein the bottom of the mold is narrower than the top of the mold.

7. The device of claim, wherein the plurality of extruded outer projections comprises a larger circumference than the tray cavity of the tray.

8. (canceled)

9. The device of claim 2, further comprising a tray comprising a tray cavity, wherein the cylindrical adapter is within the tray cavity.

10. The device of claim 1, wherein the object is the mold.
